(19) United States
(12) Patent Application Publication
(10) Pub. No.: US 2011/0297777 A1
(43) Pub. Date: Dec. 8, 2011

(54) REVERSIBLE BELT TENSIONER

(75) Inventors: Patrick Tuscher, Hendstedt-Ulzburg (DE); Sébastien Baudinet, Saint Lye la Foret (FR); Andreas Lucht, Horst (DE); Hans-Jörg Langhoff, Bonningstedt (DE)

(73) Assignee: Autoliv Development AB, Vargarda (SE)

(21) Appl. No.: 13/201,880

(22) PCT Filed: Feb. 4, 2010
(86) PCT No.: PCT/EP10/00831

§ 371 Date: Aug. 17, 2011

(30) Foreign Application Priority Data
Feb. 24, 2009 (DE) 10 2009 010 093.8

(51) Int. Cl. B60R 22/46

(52) U.S. Cl. 242/374

(57) ABSTRACT

A reversible belt tensioner (1) with a belt roller and an electric motor (3) that drives the belt roller (2) in roll-up direction, has at least two electrical contacts (11) arranged on the electric motor (3). Counter contacts (10) are fixed on the reversible belt tensioner (1), and the electrical contacts (11) of the electric motor (3) are plugged directly onto or into the counter contacts (10).

### CROSS REFERENCE TO RELATED APPLICATIONS

This application claims priority to German Patent Application No. 102009010093.8, filed Feb. 24, 2009 and PCT/EP2010/000831, filed Feb. 4, 2010.

### TECHNICAL FIELD

The invention relates to a reversible belt tensioner with a belt roller and an electric motor that drives the belt roller in roll-up direction, having at least two electrical contacts arranged at the electric motor.

### BACKGROUND OF THE INVENTION

Reversible belt tensioners are used in modern vehicles to pull a slack out of a vehicle safety belt in a pre-accident phase, and thus couple the passenger as early as possible to a vehicle deceleration during a potential subsequent accident. In addition, the passenger is made aware of a possibly dangerous situation by the activation of the reversible belt tensioner, in case this has not already been noticed.

It has proven useful to provide such reversible belt tensioners with electric motors, which drive the belt roller in roll-up direction during reversible tightening, because electric motors are especially easy to control. The electric motors have to be connected for this purpose via electrical contacts to an external power source, such as the motor vehicle battery, and/or via power lines to an external control unit.

A reversible belt tensioner is known from US 2008/0012284 AI, which has an electric motor connected via a separate contact housing to the electrical supply lines. The electric motor is connected with one side to the reversible belt tensioner during installation and then at the free side to the external electrical supply lines via the contact housing.

The disadvantage of the proposed solution is that a complex contact housing must be provided, and that the expenses for installing and contacting the electric motor are relatively high.

It is an object of the invention to provide a cost-effective belt tensioner with as little installation effort as possible.

In order to attain this object, it is proposed to provide counter-contacts fixed on the reversible belt tensioner and in plug the electric motor with the electrical contacts directly onto or into the counter-contact(s). A possibility for contact is created in this way, which can be carried out simultaneously with the installation of the electric motor on the reversible belt tensioner, and one installation step is omitted in comparison with the solution known from the prior art. Apart from that, the currently required contact housing is omitted, so that the costs are reduced. The manufacturing costs and installation time are overall reduced by means of the invention, and the source of error of forgotten contacting is eliminated.

It is further proposed to configure each of the electrical contacts of the electric motor and the counter-contacts of a dimensionally stable sheet metal. The proposed use of a dimensionally stable sheet metal ensures that the contacts do not bend away during the plugging process. The contacts can additionally contribute in this way to the support of the electric motor at least during the subsequent installation steps.

The electrical connection can further be improved by connecting the electrical contacts each other via a cutting and/or clamping connection. The withdrawal forces required for separating the contacts are increased by means of the cutting and/or clamping connection, so that a secure connection is still provided, even in case of high vibrations or after a long service life of the reversible belt tensioner.

A simple form of the cutting and/or clamping connection can be realized by arranging the electrical contacts and the counter-contacts at an angle with respect to each other and providing one of the electrical contacts and/or of the counter-contacts with a slot, into which the other contact can respectively be inserted. In this case, it is further proposed that the width of the slot is smaller than the thickness of the sheet metal of the contact to be inserted. A punctiform contact surface with a correspondingly high contact pressure, which can further be increased by means of the proposed dimensioning of the slot width, is created by means of the proposed contacting via a slot.

It is further proposed that a shaft for the transmission of the rotation to the belt roller is led out of the electric motor, and that the electrical contacts are arranged on the side of the electric motor on which the shaft is led out of the electric motor. The proposed arrangement of the contacts and the shaft extending out of the electric motor has the advantage that the modules that are in contact with the electric motor via the shaft and the contacts are likewise arranged on the same side of the electric motor. A substantially simplified construction of the entire reversible belt tensioner is obtained in this way and, with a corresponding design of the connections to the modules, the electric motor can be connected to them in a single plugging process.

In this case, it is proposed that the plugging direction of the electrical contacts to the counter-contacts is parallel to the shaft of the electric motor.

Another preferred embodiment of the invention consists in that a support unit with electronic components is provided on the reversible belt tensioner, and in that the counter-contacts are arranged on the support unit. The proposed use of the support unit for the arrangement of the counter-contacts offers the advantage that the counter-contacts are supported mechanically, so that the insertion forces acting during the plugging process are absorbed. Moreover, the electric motor can then be simultaneously connected to other electrical components, such as control circuits or processors, via the support unit. The current transmitted by the counter-contacts can in particular be processed by a control circuit on the support unit, so that the current is transmitted in the form of a control current and additional control lines are no longer required between the electric motor and the support unit.

It is further proposed to provide a transmission in a transmission housing, and to fix the support unit on the transmission housing. As a result of its function, the transmission housing is arranged overlapping the electric motor as well as the belt roller, and should thus be considered as a mechanically stable basic element of the reversible belt tensioner. Diverse sensors allocated to the electric motor and to the belt roller can further be arranged on the support unit and fastened in a single installation step on the reversible belt roller via the support unit by arranging the support unit on the transmission housing. The support unit thus forms a central component for the control and power supply of the reversible belt tensioner, which can be connected to the electric system of the vehicle via a single plugging connection. In case of a defect of the electronics of the reversible belt tensioner, the defect can easily be repaired by replacing the support unit without previously having to carry out a complex fault diagnosis.

It is further proposed to arrange the electric motor on one side of the transmission housing and the support unit on the other side of the transmission housing. The reversible belt tensioner can thus be easily installed from different sides, and the support unit configured in such a way that it can extend along the entire side of the transmission housing, because the free upper surface of the transmission housing is not limited by the electric motor on this side. Besides, as a result of the proposed arrangement, the support unit is considerably easier to replace without having to separate the electric motor from the transmission housing.

In this case, it is further proposed that the counter-contacts of the support unit and/or the electrical contacts of the electric motor totally or partially protrude through the transmission housing. The protrusion of the contacts can be advantageous from different points of view, the support unit and the electric motor can thereby support one another clamping independently on the transmission housing on account of the contact forces at least during the installation process. Moreover, the contacts can be protected against external loads, in particular mechanical loads, by the at least partial protrusion of the contacts.

It is further proposed to arrange electronic components on the support unit and to arrange the support unit on the transmission housing, in such a way that the electronic components protrude into the transmission housing. The electronic components can in this way likewise be protected against external loads, with the additional possibility of using free spaces that are available in the transmission housing, and thus increase the compactness of the reversible belt tensioner.

In order to increase the reliability of the installation process, it is proposed to arrange that the counter-contacts on the support unit in a predefined position, and to fasten the support unit to the transmission housing in a predefined position. The predefined position of the counter-contacts and the mechanical coding of the support unit ensure that the counter-contacts are in the predefined position relative to the transmission housing in all cases after the support unit is fastened.

It is furthermore proposed to attach the electric motor to the belt tensioner via the housing, and to configure the housing for the electric motor in such a way that it forms a counter bearing acting against the plugging direction of the electrical contacts to the counter-contacts. The created counter bearing prevents the electrical contacts and the counter-contacts from coming loose due to vibrations in the installed reversible belt tensioner.

A housing that is especially easy to install can be created by configuring the housing of the electric motor in pot shape, and by sliding said housing onto the electric motor in plugging direction of the electrical contacts to the counter-contacts. By means of the proposed direction in which the pot-shaped housing is slid onto the electric motor, it is prevented that the contacts connected to one another are again separated from one another while the housing is being installed. Moreover, the contacts are additionally slid together in the plugging direction by the sliding process of the transmission in case of incorrect contacting.

The invention will be explained below in more detail with reference to a preferred exemplary embodiment.

### BRIEF DESCRIPTION OF THE DRAWINGS

In the figures:

FIG. 1: shows a reversible belt tensioner with electric motor and transmission housing,

FIG. 2: shows the electric motor with a support unit,

FIG. 3: shows the electric motor with the support unit and the transmission housing.

### DETAILED DESCRIPTION OF THE DRAWINGS

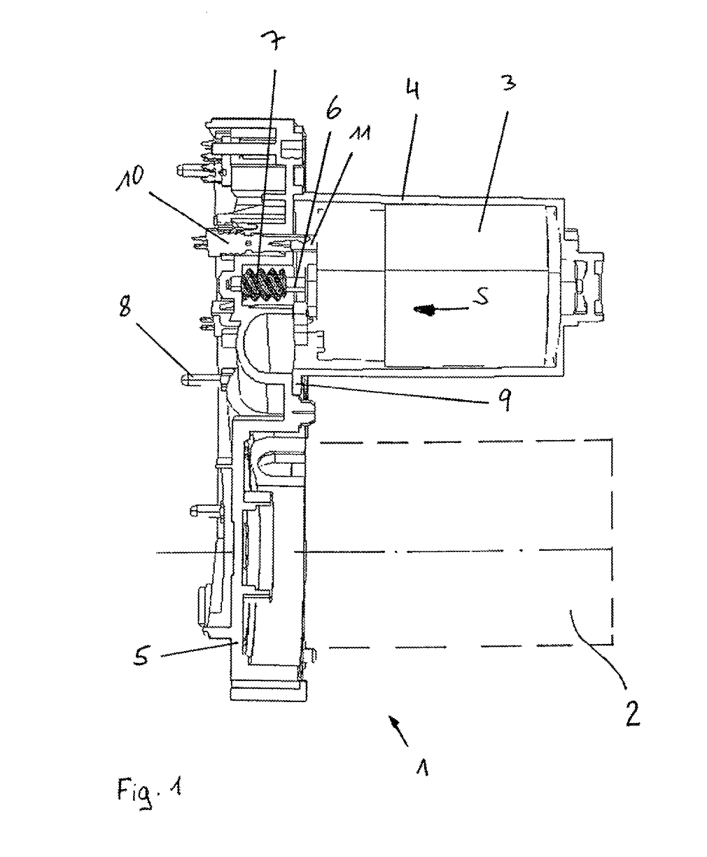

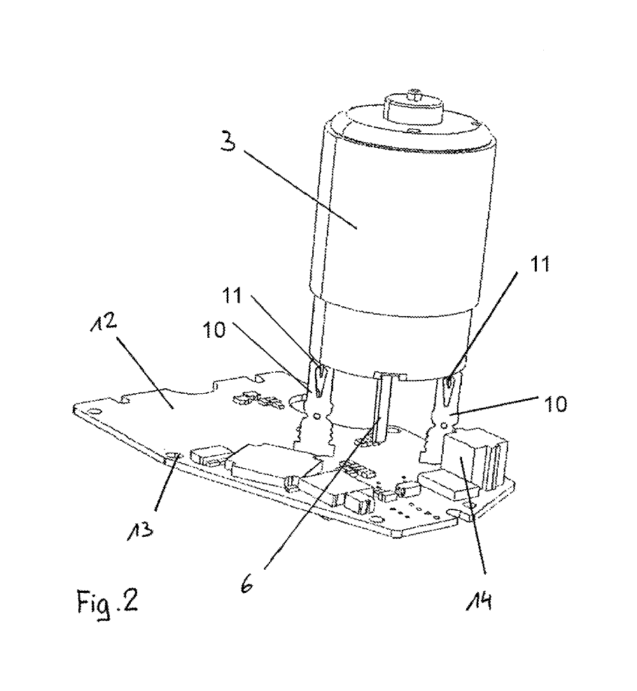

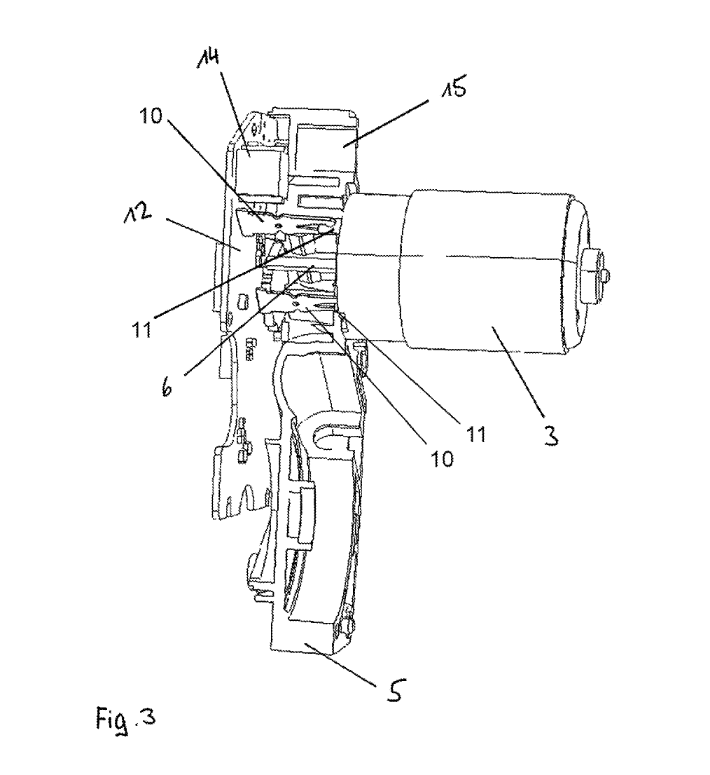

FIG. 1 shows a reversible belt tensioner 1 with a belt roller 2 and an electric motor 3. The electric motor 3 and the belt roller 2 are connected to one another via a transmission housing 5, in which a transmission that transmits the rotation of the electric motor 3 to the belt roller 2 is arranged. The electric motor 3 is plugged with the electrical contacts 11 directly into the counter-contacts 10, which are arranged on a support unit 12 (refer also to FIGS. 2 and 3). A shaft 6 of the electric motor 3 is also led out of it on the same side on which the electrical contacts 11 are arranged on the electric motor 3. A worm wheel 7 that is part of the transmission, which is not shown, is arranged on the shaft 6 and transmits the rotation of the electric motor 3 to the belt roller 2. During the installation of the electric motor 3 on the transmission housing 5 in the plugging direction “S”, the electrical contacts 11 are plugged into the counter-contacts 10 and, owing the parallel alignment of the electrical contacts 11 and of the shaft 6, said shaft 6 with the worm wheel 7 is simultaneously inserted into the transmission housing 5. Subsequently, a pot-shaped housing 4 is slid onto the electric motor 3 in plugging direction “S” and is attached to the transmission housing 5 via a clamping flange 9. After the attachment of the pot-shaped housing 4, it additionally forms a counter bearing, which acts against the plugging direction “S” and protects the electric motor 3 in the pull-off direction of the counter contacts 10.

FIG. 2 shows the electric motor 3 with the support unit 12. The counter-contacts 10, into which the electric motor 3 with the electrical contacts 11 is directly plugged, are arranged on the support unit 12. The electrical contacts 11 as well as the counter-contacts 10 are made of dimensionally stable metal strips, so that they can connect the electric motor 3 to the support unit 12 in a dimensionally stable manner at least during the installation process. Moreover, the dimensional stability of the electrical contacts 11 and of the counter-contacts 10 ensures that they do not bend away as a result of the insertion forces acting during the plugging process. Different electronic components 14 are also arranged on the support unit 12, such as processors, memory devices, additional contacts, etc., which are required for the control and power supply of the reversible belt tensioner 1. The support unit 12 thus forms a central dimensionally stable component of the reversible belt tensioner 1, wherein a fault in the electrical system of the reversible belt tensioner is easy to repair by replacing the entire support unit 12 without having to carry out a complex fault diagnosis as a result of the combination of the electronic components 14 on a single support unit 12. In addition, the support unit 12 in general provides a mechanical support for the electronic components 14 arranged on it, and in particular also for the counter-contacts 10, during the plugging process.

FIG. 3 shows the electric motor 3 with the support unit 12 and with the transmission housing 5. A holder 15 is provided in the transmission housing 5, via which the support unit 12 can be electrically connected to the electric system of the vehicle by means of a plug. The support unit 12 and the electric motor 3 are arranged on different sides of the transmission housing 5, so that the electrical contacts 11 and the counter-contacts penetrate the transmission housing 5 and are simultaneously protected thereby. Furthermore, the electrical contacts 11 and/or counter contacts 10 can be supported and/or guided during the plugging movement by walls that are laterally arranged in the transmission housing 5, so that they are not bent away laterally or directed past one another due to an incorrect alignment and therefore fail to be plugged.

Additional electronic components 14, which are arranged on the same side of the support unit as the counter contacts 12, are provided on the support unit 12. The electronic components 14 can thus likewise protrude into corresponding cavities of the transmission housing 5 in a space saving and protected manner. Furthermore, the electronic components 14 are accordingly arranged directly on the side of the support unit 12 facing the transmission, the electric motor 3 and the belt roller 2, which is particularly advantageous if the electronic components 14 are sensors that are functionally allocated to the transmission, the electric motor 3 or the belt roller 2.

The support unit 12 is provided with attachment holes 13 and thereby plugged onto the attachment pins 8. As a result of the arrangement of the attachment holes 13 and of the attachment pins 8, the attachment of the support unit 12 to the transmission housing 5 is only possible in one position. The counter-contacts 10 are also in a predefined position relative to the transmission housing 5 after the attachment of the support unit 12 on account of the mechanical coding created by the attachment holes 13 and the arrangement of the counter-contacts 10 on the support unit 12. The electric motor 3 can be plugged directly onto the counter-contacts 10 and attached to the transmission housing 5 once the support unit 12 has been fastened as result of the positioning of the counter-contacts 10 in a predefined position on the transmission housing 5. The arrangement of the counter-contacts 10 in a predefined position relative to the transmission housing 5, and thus relative to the holder for the shaft 6 provided in the transmission housing 5, is important because the shaft 6 extending out of the electric motor 3 and the electrical contacts 11 arranged on the electric motor 3 are in a fixed relationship to one another.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A reversible seat belt tensioner comprising
an electric motor generating a rotational movement,
a seat belt retractor drivable in a retraction direction by the electric motor,
at least two electric contacts located at the electric motor,
at least two counter contacts fixed at the seat belt retractor, the counter contacts being in direct contact with the electric contacts.

2. The reversible seat belt tensioner according to claim 1, further comprising that the electric contacts of the electric motor and the counter contacts each are formed from a dimensionally stable sheet metal.

3. The reversible seat belt tensioner according to one of the preceding claims, further comprising that the electric contacts and the counter contacts are connected to each other via a connection formed by at least one of cutting and clamping.

4. The reversible seat belt tensioner according to claim 3, further comprising that the connection is formed by pairs of contacts consisting of one of the electric contacts and one of the counter contacts arranged at an angle relative to each other, one of the contacts of each pair comprising a slit, configured for inserting the respective other one of the contacts.

5. The reversible seat belt tensioner according to claim 4, further comprising that the width of the slit is smaller than the thickness of the sheet metal of the insertable contact.

6. The reversible seat belt tensioner according to claim 1, further comprising a shaft for transmitting the rotational movement to the seat belt retractor the shaft being guided out of the electric motor on a side on which the electric contacts are located.

7. The reversible seat belt tensioner according to claim 6, further comprising that a plugging direction of the electric contacts relative to the counter contacts is aligned in parallel to the shaft of the electric motor.

8. The reversible seat belt tensioner according to one of the preceding claims, further comprising a support unit with electronic components, the counter contacts being located on the support unit.

9. The reversible seat belt tensioner according to claim 8, further comprising a gear unit housing for mounting a gear unit between the electric motor and the seat belt retractor, the support unit being fixed at the gear unit housing.

10. The reversible seat belt tensioner according to claim 9, further comprising that the electric motor is located on one side of the gear unit housing, and that the support unit is located on the other side of the gear unit housing.

11. The reversible seat belt tensioner according to claim 10, further comprising that at least the counter contacts of the support unit or the electric contacts of the electric motor extend at least partially through the gear unit housing.

12. The reversible seat belt tensioner according to claim 9, further comprising electronic components located on the support unit, the support unit being located at the gear unit housing in such a way that the electronic components extend into the gear unit housing.

13. The reversible seat belt tensioner according to claim 9, further comprising that the counter contacts are located on the support unit in a predetermined position, and that the support unit is configured to be fastened in a predetermined position to the gear unit housing via a mechanical coding.

14. The reversible seat belt tensioner according to claim 1, further comprising a housing for fastening the electric motor to the seat belt tensioner, the housing forming a counter bearing for the electric motor, the counter bearing acts against a plugging direction of the electric contacts toward the counter contacts.

15. The reversible seat belt tensioner according to claim 14, further comprising that the housing of the electric motor has a cup-shaped configuration, and is slid onto the electric motor in the plugging direction of the electric contacts toward the counter contacts.
